(19) United States
(12) Patent Application Publication
(10) Pub. No.: US 2026/0009512 A1
(43) Pub. Date: Jan. 8, 2026

(54) SIMULATED REALISTIC FLAME MECHANISM FOR ELECTRIC FIREPLACES

(71) Applicant: WOLF STEEL LTD., Barrie (CA)

(72) Inventors: Cuong VO, Barrie (CA); Jacob WILTSHIRE, Barrie (CA); Dominique VISCARDI, Barrie (CA); Thiru Muruga Acharapakkam DORAISWAMY, Barrie (CA)

(21) Appl. No.: 19/241,352

(22) Filed: Jun. 17, 2025

Related U.S. Application Data
(60) Provisional application No. 63/667,926, filed on Jul. 5, 2024.

(51) Int. Cl. F21S 10/04; F21Y 109/00; F21Y 113/00

(52) U.S. Cl. CPC F21S 10/04; F21Y 2109/00; F21Y 2113/00

(57) ABSTRACT

A layered simulated flame mechanism for use in an electric fireplace, the layered simulated flame mechanism comprising: two or more video display surfaces, spaced apart, and oriented in layers relative to each other by one or more of (i) different elevations, (ii) different orientations in a horizontal plane, or (iii) different orientations in a vertical plane, one or more dedicated video processors transmitting flame videos onto each of the display surfaces, generating a simulated flame on each of the video display surfaces, wherein the spacing and orientation of the two or more video display surfaces relative to each other creates a three-dimensional flame appearance.

### CROSS REFERENCE TO RELATED APPLICATION(S)

This application claims the benefit of U.S. Provisional Application No. 63/667,926 filed Jul. 5, 2024, for “SIMULATED REALISTIC FLAME MECHANISM FOR ELECTRIC FIREPLACES” by Cuong Vo, et al., the disclosure of which is incorporated herein by reference in its entirety.

### TECHNICAL FIELD

The present disclosure relates generally to the field of electric fireplaces, and in particular to a simulated flame mechanism for use in such fireplaces.

### BACKGROUND

Electric fireplaces continue to increase in popularity, particularly in regions or applications where the aesthetic effect of a fireplace is desired, but where the burning of wood, natural gas or propane is prohibited or expensive, or where the heat output of a gas or wood-burning fireplace may not be necessary.

Advances in flame simulation technologies have enhanced the ability of manufacturers to offer products with a simulated flame that more closely mimics that of a traditional wood burning or gas burning fireplace. Nevertheless, in spite of advances that have been made in the electric fireplace industry, there continues to exist a desire on the part of both manufacturers and consumers alike to further enhance the visual effects of electric fireplaces so that they more closely align with those of a burning flame.

### SUMMARY

Accordingly, in an embodiment the present disclosure provides a simulated flame mechanism for use in an electric fireplace, the simulated flame mechanism comprising two or more video display surfaces that could include a panel using organic light emitting diodes, a liquid crystal display, a LED display, a plasma display, or another suitable display. The video display surfaces are spaced apart and oriented relative to each other by one or more of (i) different elevations, (ii) different angular orientations in a horizontal plane, or (iii) different orientations in a vertical plane, generating the image of a simulated flame on each of the video display surfaces, wherein the spacing and orientation of the two or more video display surfaces relative to each other creates a three-dimensional flame appearance when light from the one or more video processors is transmitted thereto.

In another embodiment there is provided a simulated flame mechanism for use in an electric fireplace, the simulated flame mechanism comprising: a first, a second, and a third video display surface, the video display surfaces spaced apart from one another with the second video display surface positioned between the first and the third video display surfaces, the first, second, and third video display surfaces oriented in a stepped configuration with the first video display surface at a first elevation, the second video display surface at a second elevation, and the third video display surface at a third elevation, the second elevation being greater than the first elevation and the third elevation being greater than the second elevation; and a video processor associated with each of the display surfaces, each video processor transmitting video signals onto its respective display surface to generate the image of a simulated flame on the respective video display surface, wherein the spacing apart of the video display surfaces and their stepped configuration creates a three-dimensional flame appearance when video signals from the video processors is transmitted onto the video display surfaces.

In yet a further embodiment the present disclosure concerns a simulated flame mechanism for use in an electric fireplace, the simulated flame mechanism comprising two or more video display surfaces oriented relative to one another by one or more of (i) different elevations, (ii) different angular orientations in a horizontal plane, or (iii) different angular orientations in a vertical plane; an video processor associated with each of the video display surfaces, each video processor generating the image of a simulated flame on its respective video display surface; and a simulated fire log set comprising one or more simulated fire logs, one or more of the video display surfaces having an opening to receive a simulated fire log therethrough. In an embodiment the second elevation is greater than the first elevation and the third elevation is less than the second elevation.

### BRIEF DESCRIPTION OF THE DRAWINGS

For a better understanding of the present disclosure, and to show more clearly how it may be carried into effect, reference will now be made, by way of example, to the accompanying drawings which show exemplary embodiments of the present disclosure in which:

FIG. 1 is a front perspective view of an electric fireplace insert having a simulated flame mechanism in accordance with an embodiment of the present disclosure.

FIG. 2 is an upper side perspective view of the simulated flame mechanism of the embodiment of the electric fireplace shown in FIG. 1, where multiple video processors exist.

FIG. 3 is an upper side perspective view of the simulated flame mechanism of an alternate embodiment of the electric fireplace shown in FIG. 1, where a combination of video processors and flame reflections mechanism exist.

FIG. 4 is an upper side perspective view of the simulated flame mechanism of an alternate embodiment of the electric fireplace shown in FIG. 1, where a combination of video processors and flame reflections mechanism exist.

FIG. 5 is a side elevation view of an alternate embodiment of the simulated flame mechanism shown in FIG. 2.

FIG. 6 is a side elevation view of an alternate embodiment of the simulated flame mechanism.

FIG. 7 is an upper side perspective view of the simulated flame mechanism shown in FIG. 6.

FIG. 8 is an illustrative view of a series of different forms of video display surfaces which could be used in different embodiments of the simulated flame mechanism in accordance with the present disclosure.

FIG. 9 is a view showing an embodiment of the present disclosure where the fire log set includes grooves to receive video display surfaces therein.

FIG. 10 is a schematic drawing of an embodiment of the present disclosure that utilizes electrochromic glass.

### DETAILED DESCRIPTION

The present disclosure may be embodied in several different forms. The specification and drawings that follow describe and disclose some of the specific forms of the present disclosure.

With reference to the attached drawings, illustrative embodiments of a simulated flame mechanism constructed in accordance with the present disclosure will be described in further detail.

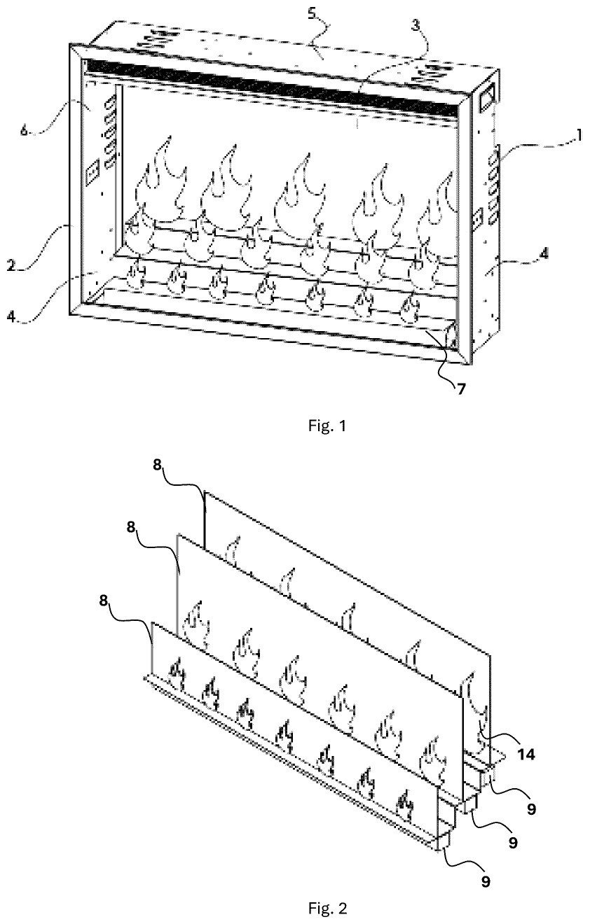

In FIG. 1 there is shown an electric fireplace 1 that is comprised generally of a housing 2 having a back surface 3, side surfaces 4, a top 5, and a front glass or viewing window 6. A simulated flame mechanism 7 is positioned within the housing and between glass 6 and back surface 3.

In accordance with the present disclosure, simulated flame mechanism 7 is comprised of two or more video display surfaces 8 and one or more video processors 9 that transmit video signals onto the two or more video display surfaces to generate the image of a simulated flame on each of the respective video display surfaces. From a thorough understanding of the present disclosure it will be appreciated that video processors 9 controls the desired still or moving image display and intensity of video signals that is transmitted to the video display surface or surfaces to create the image of a simulated flame that attempts to mimic the flame of a wood or gas burning fire. In the case of the embodiments of the present disclosure shown in the attached drawings, each video display surface 8 has its own dedicated video processor 9.

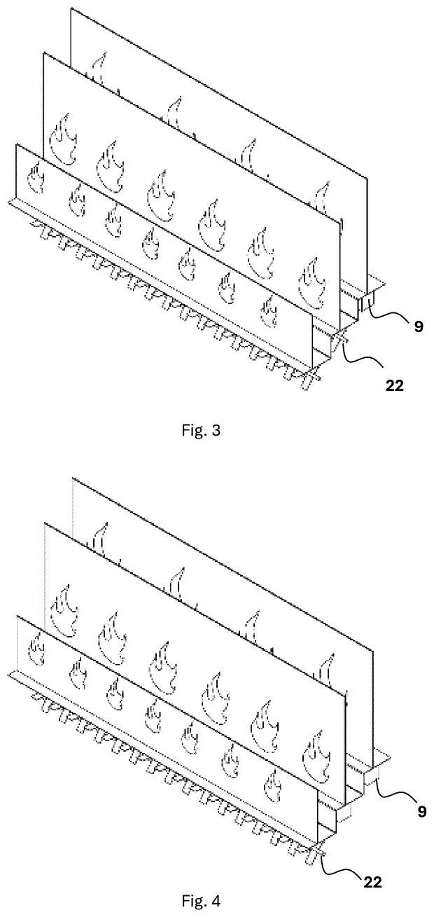

To enhance the image of a simulated flame on video display surfaces 8, and to help to create a three-dimensional flame appearance, the respective video display surfaces 8 are spaced apart and oriented relative to one another by one or more of (i) different elevations, (ii) different angular orientations in a horizontal plane, or (iii) different orientations in a vertical plane. For example, in the embodiment shown in FIGS. 2 and 3, the video display surfaces are oriented in a stepped configuration and at different elevations such that the projection of video signals onto the video display surfaces creates the appearance of flames at different heights, at different depths within housing 2. That is, in this embodiment the video display surfaces comprise a first video display surface 11, a second video display surface 12, and a third video display surface 13, where each of the respective surfaces are generally parallel to one another. The first video display surface 11 is positioned closest to glass 6 and the third video display surface 13 is positioned closest to back 3 of housing 2. Second video display surface 12 is located between the first and third video display surfaces. It will also be noticed through reference to FIGS. 2 and 3 that the stepped configuration of the video display surfaces results in second video display surface 12 being positioned and extending vertically higher than first video display surface 11. Similarly, third video display surface 13 is positioned and extends vertically higher than second video display surface 12. The net effect of the stepped configuration of the three video display surfaces creates the appearance of flames at an increasing height as one moves rearwardly from the front of housing 2 toward its back. In the depicted embodiment, each video display surface also has its own dedicated video processor, however, as noted previously other forms and other numbers of video processors could be used.

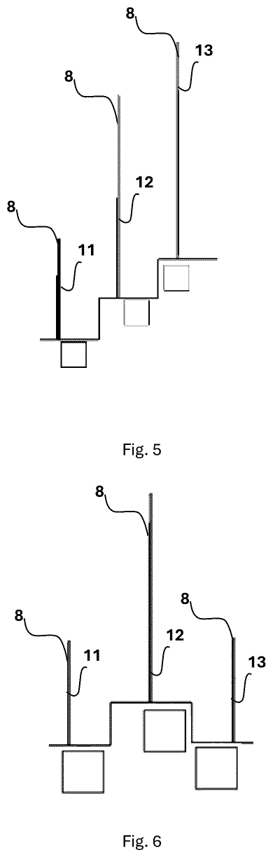

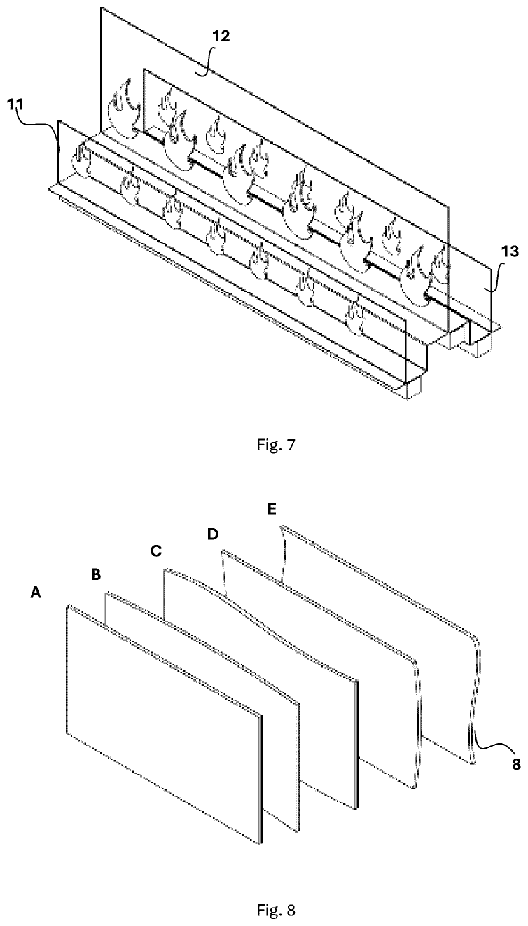

FIGS. 4 through 7 illustrate alternate embodiments of video display surfaces, that could typically be used in the case of a double-sided fireplace, wherein back 3 of housing 2 is a glass or viewing window, similar to front 6. In this embodiment, three separate video display surfaces are utilized. In other embodiments two or more surfaces could be present. With specific reference to FIG. 4, a first video display surface 11 is located adjacent to where glass 6 of the fireplace would be positioned, and a third video display surface 13 is oriented adjacent to where back 3 (comprised of glass or a viewing window) would be positioned. It will also be noted that second video display surface 12 is positioned between surfaces 11 and 13, and is at a higher elevation, and extends vertically upward to a greater degree, than first or third video display surfaces 11 and 13. In many applications of double-sided electric 9 fireplaces, it is expected that first and third video display surfaces 11 and 13 would be positioned at approximately the same elevation and would extend upwardly to approximately the same degree.

Each video display surface in FIGS. 4 through 7 has its own dedicated video processor. While the surfaces may also receive secondary projections from other video processor sources, in addition to the dedicated source. The net result of the video display surfaces in the embodiment shown in FIGS. 4 through 6 is to create the image of flames on video display surfaces positioned at different “depths” within housing 2, and images of flames having different relative heights when viewed from either side of the fireplace.

The present disclosure also contemplates different shapes and sizes for video display surfaces 8. For example, the video display surfaces may be planar, or may be whole, or in part, nonplanar with curves or contours. FIG. 8 demonstrates five different potential forms of video display surfaces that could be used. Video display surface A represents a generally planar video display surface. Video display surface B is concave in a vertical orientation. Video display surface C is an example of a video display surface that is in the form of a wave in plan view. Video display surface D is concave in a horizontal orientation. Video display surface E demonstrates a wave pattern when viewed from the end of the video display surface. In one embodiment the simulated 11 flame mechanism may comprise a plurality of video display surfaces, which may be alike or which may be any combination of one or more of the types shown in FIG. 8.

One or more of the video display surfaces may contain flame effects 14. Flame effects 14 could take the form of holographic film, painted, or other effect on surface 8 that is designed to enhance a natural flame and/or three-dimensional flame appearance when light from the flicker element is cast upon the video display surface. Flame effect 14 may also comprise one or more flame cut-outs that, together with the light that is cast upon the surface by the flicker element, enhances the displayed image of a moving flame.

Depending on the application and the desired image, video display surfaces 8 may be oriented in an angular or intersecting manner, or may be oriented in other discrete manners to create a customized flame appearance.

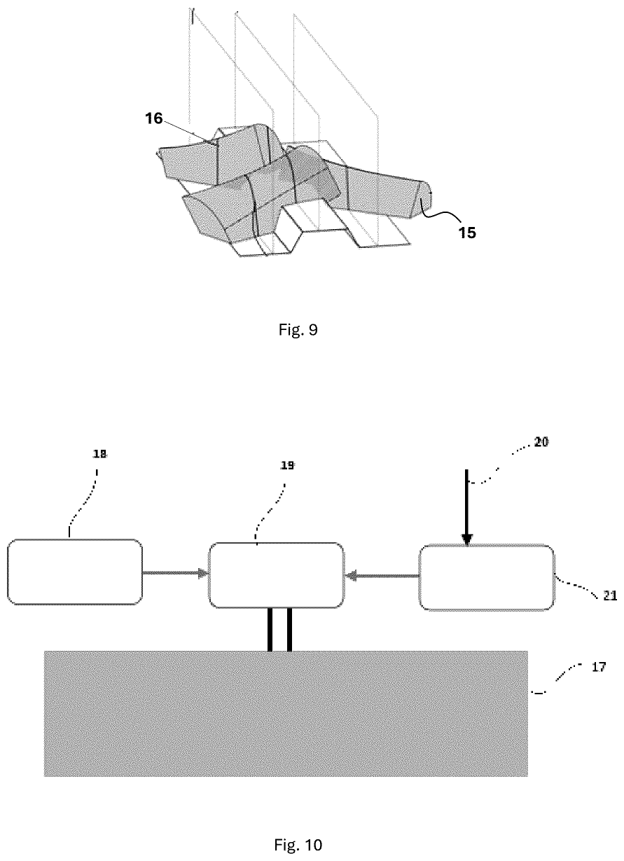

In some applications it is expected that electric fireplace 1 will also include a simulated fire log set 15, similar to that which exists in many current electric and gas burning fireplaces. In an embodiment of the present disclosure, one or more video display surfaces 8 may include openings through which a simulated log of fire log set 15 may extend. In this instance, the extension of a fire log through an associated video display surface will enable the presentation of the image of a burning flame that appears to emanate directly from a burning log, adding further to the realistic effect and three-dimensional effect that is created (see FIG. 9). In an alternate embodiment, the fire log set 15 may be formed with a groove or grooves 16 for the receipt of one or more video display surfaces therein, and to support the video display surface or surfaces at a desired position vis-à-vis the fire log set and at a desired degree of inclination from horizontal (see FIG. 9). It will be understood that the embodiment of FIG. 9 can create essentially the same image of a burning fire through a slightly different structure compared to that of FIG. 8. In the case of a see-through or two sided fireplace, a groove 16 positioned approximately at the midpoint of the fire log set, may be used to retain a centrally located video display surface upon which can be projected two separate images of a burning flame (one on each side of the video display surface) to present the illusion of a burning fire from either side of the fireplace.

In still a further embodiment, one or more video display surfaces 8 may comprise or have associated with it electrochromic glass or smart glass (also known 13 as polymer dispersed liquid crystal display or PDLC glass). That is, the entire video display surface could potentially be formed from electrochromic glass, or a portion of the video display surface may be fitted with electrochromic glass. FIG. 10 is a schematic drawing showing the primary components that would be used where electrochromic glass is present. Here, electrochromic glass 17 is connected to a power source 18 that would commonly feed a transformer 19, that powers glass 17. A user would typically control the degree of transparency of glass 17 through a user input 20 (which may be a manual control, an app on a smart phone, etc.) that is received by a power controller or processor 21. Alternately, power processor 21 could be programmed to control the degree of transparency of glass 17 in accordance with predetermined parameters according to the degree or “extent” of a burning fire that is to be mimicked, and other factors that impact the overall visual appearance that is created.

From a thorough understanding of the present disclosure, it will be appreciated that a combination of the number, shape, angular orientation, and vertical offset of a plurality of video display surfaces 8 helps to create an appearance of a more realistic, three-dimensional fire. Video processors 9 that can vary color, speed of movement/rotation, intensity, sequencing, and layering add further to the overall 14 natural appearance. Light can be projected from the video processors at different angles and elevations, and through one or more different lenses. Further, the orientation of individual projection services both relative to fireplace 1 and relative to each other adds to the overall three-dimensional effect.

It is to be understood that what has been described are the preferred embodiments of the present disclosure. The scope of the claims should not be limited by the preferred embodiments set forth above, but should be given the broadest interpretation consistent with the description as a whole.

What is claimed is:

1. A layered simulated flame mechanism for use in an electric fireplace, the layered simulated flame mechanism comprising:
two or more video display surfaces, spaced apart, and oriented in layers relative to each other by one or more of (i) different elevations, (ii) different orientations in a horizontal plane, or (iii) different orientations in a vertical plane; and
one or more dedicated video processors transmitting flame videos onto each of the video display surfaces, generating a simulated flame on each of the video display surfaces,
wherein the spacing and orientation of the two or more video display surfaces relative to each other creates a three-dimensional flame appearance.

2. The layered simulated flame mechanism as claimed in claim 1, wherein the video display surfaces are oriented in a stepped configuration relative to each other at different elevations to create an appearance of flames of different heights at different depths within the fireplace.

3. The layered simulated flame mechanism as claimed in claim 1, wherein at least one video display surface is oriented approximately vertically.

4. The layered simulated flame mechanism as claimed in claim 1, wherein each flame video display surface has a dedicated video processor.

5. The layered simulated flame mechanism as claimed in claim 1, wherein at least one video display surface comprises electrochromic glass, wherein the electric fireplace includes a controller, and wherein the controller controls the one or more dedicated video processors and the electrochromic glass.

6. The layered simulated flame mechanism as claimed in claim 1, comprising a simulated fire log set, the simulated fire log set comprising one or more simulated logs and having one or more grooves located between front and rear edges of the log assembly to receive and retain one or more of the video display surfaces therein.

7. The layered simulated flame mechanism as claimed in claim 1, where a speed of image movement at multiple layers and a speed of light reflection on the simulated logs are synchronized by a centralized controller, according to an input.

8. The layered simulated flame mechanism as claimed in claim 1, where a color of image movement at multiple layers and a color of light reflection on the simulated logs are synchronized by a centralized controller, according to an input.

9. The layered simulated flame mechanism as claimed in claim 1, wherein:
the two or more video display surfaces comprise a first, a second, and a third video display surface;
the first, second, and third video display surfaces are positioned side by side and aligned generally parallel to one another with the second video display surface located between the first and the third video display surfaces; and
the second video display surface extends vertically higher than the first and the third video display surfaces.

10. The layered simulated flame mechanism as claimed in claim 1, wherein:
the two or more video display surfaces comprise a first, a second and a third video display surface;
the first, second, and third video display surfaces are positioned side by side and arranged in generally parallel rows with the second video display surface located between the first and the third video display surfaces;
the first video display surface has a vertical height less than the second and third video display surfaces;
the second video display surface has a vertical height less than the third video display surface; and
each video display surface has its own dedicated video processor while also receiving secondary projections from other video processor sources.

11. A layered simulated flame mechanism for use in an electric fireplace, the layered simulated flame mechanism comprising:
a first, a second, and a third video display surface, the video display surfaces spaced apart from one another with the second video display surface positioned between the first and the third video display surfaces, the first, second, and third video display surfaces oriented in a stepped configuration with the first video display surface at a first elevation, the second video display surface at a second elevation, and the third video display surface at a third elevation, the second elevation being greater than the first elevation and the third elevation being greater than the second elevation; and
a video processor associated with each of the video display surfaces, each video processor transmitting light onto its respective video display surface to generate an image of a simulated flame on the respective video display surface;
wherein the spacing apart of the video display surfaces and their stepped configuration creates a three-dimensional flame appearance when light from the video processors is transmitted onto the video display surfaces.

12. The layered simulated flame mechanism as claimed in claim 11, wherein at least one video display surface is oriented at an angle relative to vertical.

13. The layered simulated flame mechanism as claimed in claim 11, wherein at least one video display surface is oriented at an angle relative to vertical and at least one video display surface is approximately vertical.

14. The layered simulated flame mechanism as claimed in claim 11, wherein one or more of the video display surfaces is non-planar and has curves or contours.

15. The layered simulated flame mechanism as claimed in claim 11, wherein at least one video display surface comprises electrochromic glass, wherein the electric fireplace includes a controller, and wherein the controller controls the electrochromic glass and the video processor associated with the at least one video display surface to together create a desired image on the at least one video display surface.

16. The layered simulated flame mechanism as claimed in claim 11, wherein one or more of the video display surfaces includes a holographic film, the holographic film enhancing the three-dimensional flame appearance.

17. The layered simulated flame mechanism as claimed in claim 11, further comprising a simulated fire log set having one or more simulated logs, wherein one or more of the video display surfaces has an opening to receive a simulated log therethrough.

18. The layered simulated flame mechanism as claimed in claim 11, comprising a simulated fire log set, the simulated fire log set comprising one or more simulated logs and having one or more grooves to receive and retain one or more video display surfaces therein.
